(19) United States
(12) Patent Application Publication
(10) Pub. No.: US 2015/0037757 A1
(43) Pub. Date: Feb. 5, 2015

(54) METHOD FOR ATTACHING A DENTAL PROSTHESIS HAVING MULTIPLE ABUTMENTS

(71) Applicant: Norman Kwan, St. Catherine's (CA)

(72) Inventor: Norman Kwan, St. Catherine's (CA)

(21) Appl. No.: 13/959,161

(22) Filed: Aug. 5, 2013

(51) Int. Cl. A61C 8/00; A61C 13/00

(52) U.S. Cl. CPC A61C 8/0051; A61C 8/0022; A61C 8/006; A61C 13/0004
USPC 433/174; 433/202.1

(57) ABSTRACT

A method for attaching a dental prosthesis is disclosed. The prosthesis has multiple implants with different trajectories. In use, each implant is disposed within a patient's jawbone and their relative locations are mapped. The prosthesis is formed from multiple abutments with each abutment having a protrusion. The protrusions are machined to produce a common path of insertion into recesses of the implants.

### BACKGROUND OF THE INVENTION

The subject matter disclosed herein relates to dental implants. In general, dental implants are very expensive, ranging in cost from approximately three to six hundred dollars (excluding laboratory costs). However, the labor associated with the implant procedure often costs eight to twenty times the amount of the implant itself, ranging from about three to four thousand dollars per tooth. One of the reasons for this substantial cost is the multiplicity of steps required by the implant procedure. It is therefore desirable to provide alternative methods for installing dental implants that address at least some of these shortcomings. The discussion above is merely provided for general background information and is not intended to be used as an aid in determining the scope of the claimed subject matter.

### BRIEF DESCRIPTION OF THE INVENTION

A method for attaching a dental prosthesis is disclosed. The prosthesis has multiple implants with different trajectories. In use, each implant is disposed within a patient's jawbone and their relative locations are mapped. The prosthesis is formed from multiple abutments with each abutment having a protrusion. The protrusions are machined to produce a common path of insertion into recesses of the implants. This process is particularly advantageously when multiple implants are being installed since it permits the dental professional to take advantage of economy of scale. This scaling advantage is realized because the geometric configuration of each implant can be changed “on the fly” while requiring only a single surgical operation for the patient.

In a first exemplary embodiment, a method for attaching a dental prosthesis having multiple abutments is provided. The method comprises forming a plurality of holes in a patient's jawbone. Implant are installed into each of the holes. Each implant includes a recess having at least two adjacent walls. The patient's jawbone is permitted to heal thereby affixing the implants into the holes. The patient's mouth is digitally mapped with a computer to produce a three dimensional map including a map of the location of the top portion of the implant of each hole, to determine the relative position of each of the implants. First and second abutments are attached with a bridge to form a dental prosthesis, the first abutment and second abutment having respective first and second protrusions. Each protrusion has at least two adjacent flat-edged walls that extend below the bridge. The protrusions are machined, based on the three dimensional map, to produce a common path of insertion into the recesses of the first implant and the second implant.

In a second exemplary embodiment, a method for attaching a dental prosthesis having multiple abutments is provided. The method comprises forming a plurality of holes in a patient's jawbone. Implant are installed into each of the holes. Each implant includes a recess having at least two adjacent walls. The patient's jawbone is permitted to heal thereby affixing the implants into the holes. The patient's mouth is digitally mapped with a computer to produce a three dimensional map including a map of the location of the top portion of the implant of each hole, to determine the relative position of each of the implants. A dental prosthesis is machined, based on the three dimensional map. The dental prosthesis comprises a first abutment attached by a bridge to a second abutment, the first and second abutment having respectively first and second protrusions, the protrusions being machined to produce a common path of insertion of the first and second protrusions into the recesses of the first implant and the second implant.

In a third exemplary embodiment, a monolithic dental prosthesis having multiple abutments is provided. The dental prosthesis comprises a plurality of abutments, each joined to at least one adjacent abutment by a bridge. Each abutment comprises a protrusion for insertion into a recess of a dental implant. At least two of the abutments have a different geometry to provide a common path of insertion.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a front view of an exemplary prosthesis;

FIG. 2 a flow diagram depicting an exemplary method of attaching a dental prosthesis;

FIG. 3A and FIG. 3B are schematic side views of a jawbone and an implant disposed within the jawbone, respectively;

FIG. 3C depicts alternative embodiments of a recess;

FIG. 4 depicts an exemplary scan ball while

FIG. 5 illustrates how the scan ball is used to determine a longitudinal axis of the implant;

FIG. 6 depicts an exemplary bridge formed from multiple abutments;

FIG. 7 shows an incorrectly contacting section that prevents a common path of insertion;

FIG. 8 shows the incorrectly contacting section removed; thereby providing a common path of insertion;

FIG. 9 is an exploded view of an implanting including an abutment and screw attachment;

FIG. 10 is a depiction of implants after they have been installed into a patient's upper jawbone;

FIG. 11 shows a schematic depiction of the relative orientation of the various implants is shown with the longitudinal axes illustrated;

FIG. 12 illustrates scan balls securely attached to the implants using screw attachments;

FIG. 13 shows an optical scanner being used to digitally map the location of optical markers of the scan balls;

FIG. 14 shows the output of a digital map of the patient's mouth;

FIG. 15 depicts the map having been altered to remove the gums and show the relative orientation of the various implants as they extend into the jawbone;

FIG. 16 illustrates which portions of the protrusions must be machined to produce a common path of insertion; and

FIG. 17 depicts a prosthesis with appropriately machined protrusions.

### DETAILED DESCRIPTION OF THE INVENTION

Many conventional implantation procedures begin with a fixture (also known as an implant) being purchased. The fixture so purchased must then be placed into an instrument set for fixture placement. Once the fixture is disposed in the instrument, a fixture mount is then attached to the fixture by means of a wrench and a screwdriver. Next, a connection to contra-angle handpiece is attached to a handpiece and the implant assembly is then driven into the jawbone of a patient. Thereafter, the fixture mount is removed from the fixture and a cover screw is inserted into the fixture. Next, the surgical site is allowed to heal for about three to about six months.

After the healing period, the implant is exposed by surgical procedures and the cover screw is removed. A healing abutment is then attached to the fixture. In general, the healing abutment is left in place for approximately two to three weeks, depending upon how the patient's tissue has healed. Thereafter, the healing abutment is removed and an implant abutment is attached to the fixture. The type of implant abutment used will depend on the requirements of the patient. Thus, for example, one may use a standard abutment, an EsthetiConee abutment, a CeraOneo abutment, a Ball Attachment, an Angulated Abutment, and other standard and/or proprietary abutments.

Next, the desired prosthesis is formulated by conventional means and adjusted to fit within the patient's mouth. For a single-tooth prosthesis, generally one to two impressions are made to capture the size and shape of the abutment to the tooth. Multiple mock-ups and adjustments are often made before the final prosthesis is finally secured to the implant. For a multiple-tooth prosthesis, the course of treatment is not always predictable; multiple impressions and frameworks need to be created involving multiple appointments. Typically, the entire treatment, including initial implant placement and second stage surgery, would span a period of time ranging from two to approximately nine to eighteen months, or longer, before the final prosthesis is secured within the patient's mouth.

In addition to the increased time, labor and costs, various theoretical and practical implications need to be considered for multiple tooth or full-mouth reconstruction. In multiple restorations, “draw,” “common path of insertion,” “parallel,” “passivity” and “stability” are terms that describe the most critical objectives of such a procedure. Draw is perhaps best described as the effects of friction, but not binding.

Multiple implants and their abutments are rarely, if ever, perfectly aligned within the patient's mouth. Traditional methods of multiple tooth restoration require the heads/abutments and prostheses to be individually modified or made parallel until a common path of insertion is achieved and until the prosthesis is passive with respect to all of the abutments and soft tissue. In other words, it must be possible to place the prosthesis in position by moving the structure onto the abutments in a straight line (i.e., the common path of insertion), with sufficient friction or draw to ensure a firm fit. Once in place, the prosthesis must be passive, which means it must fit the abutments and the soft tissue profile such that there is no undue tension and no motion can take place.

These procedures require a myriad number of instruments and parts, typically two surgical procedures, many trips by the patient to the dentist, increased treatment times and prolonged healing periods resulting in an overall reduced quality of life for the patient. Further, an expensive, time consuming and labor intensive “trial and error” system is crucial to such procedures because each prosthesis is custom made to the particular shape, design, location and quantity of abutments for each patient. Therefore, not only are the processes tedious and expensive, but, also, each surgical procedure introduces a certain element of risk, pain, and suffering. Conventional implant impression-taking can be cumbersome, time consuming, and prone to errors.

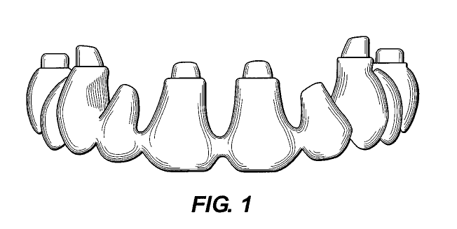

In view of the above, there is a need for a dental implant system and associated process of attachment integrating this treatment processes with a non-invasive, non-contact intra-oral scan producing a digital impression and virtual model which can be edited, design and CAD/CAM manufactured process that are simple, predictable and effective. In particular, it is desirable that the dental implant system and attachment process can be reduced to a minimum without any additional steps to the insertion of the final prosthesis after the digital impression is taken. Also see United States Publication Nos. 2011/0129799; 2006/0078847; U.S. Pat. Nos. 5,338,197; 5,564,924; 6,068,479 and 7,207,800 each to Kwan. The content of each of the aforementioned patent publications and issued patents is hereby incorporated by reference in their entirety. An exemplary prosthesis is shown in FIG. 1.

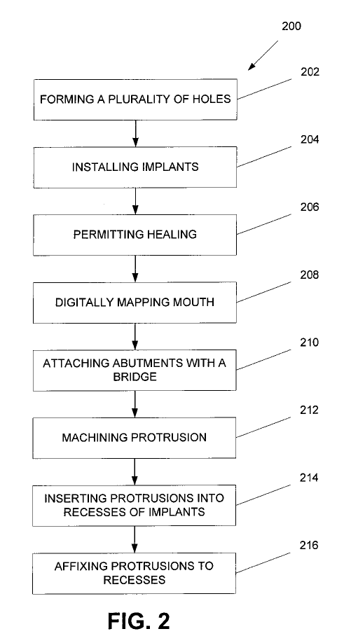

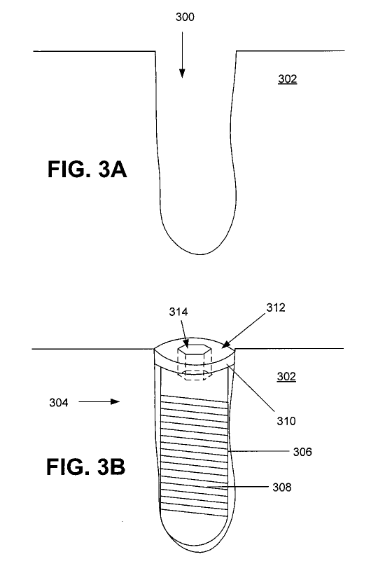

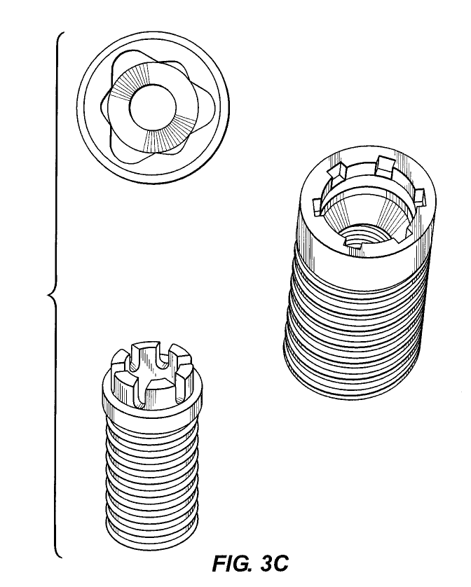

As shown in FIG. 2, one embodiment of the present invention contemplates a method 200 of dental reconstruction. The method 200 comprises a step 202 of forming a plurality of holes 300 in a patient's jawbone 302 during a single surgery. See FIG. 3A. The holes 300 may be drilled to be sufficiently deep to receive only a length of an implant (see implant 304). In general, the hole is about eight to about eighteen millimeters deep. The holes 300 are positioned in an edentulous space in the patient's mouth. In step 204, an implant is installed into each of the holes. One exemplary implant 304 is shown in FIG. 3B. An implant is the portion of a dental prosthesis that is disposed within the jawbone of a patient. The implant 304 is monolithic and comprises a base 306 that may include threads 308 and a neck 310 disposed above the base 306. The neck 310 terminates at a top surface 312. The entire top surface 312 of implant 304 is planar. The implant 304 comprises a recess 314 that is disposed below the top surface 312. In the embodiment of FIG. 3B the recess 314 is disposed entirely below the top surface 312. In step 206, the jawbone 302 is permitted to heal to affix the implants 304 into their respective holes 300. For example, the jawbone 302 may be permitted to heal for between three and six months. In one embodiment, a healing ball is retained in the recess 314 by a screw connection. See, for example, U.S. Pat. No. 5,564,924 the content of which is hereby incorporated by reference into this specification. The healing ball may be formed from a variety of materials including medical-grade polymer, castable material such as “PEEK” Poly Ether Ether Ketone or Poly Aryl Ether Ketone “(PAEK)” and other biocompatible polymeric materials which is discloses in US application number 20100099058, the content of which is hereby incorporated by reference into this specification. The healing ball has a protrusion that is similar to the protrusion of scan ball 400 that is described elsewhere in this specification. The healing ball obstructs tissue re-growth during healing to avoid a second surgery. After the desired time of healing, no additional surgical procedure is required, unlike the prior art process (which necessitated second stage surgery to remove the cover screw used in the process and to attach the prosthetic abutment). By comparison with prior art processes, applicant's implant is already attached. Healing aids may be used to promote healing. For example, the implant 304 may include coated surfaces. See U.S. Pat. No. 7,207,800, the content of which is hereby incorporated by reference. The indexing of the flat-edged protrusion of the healing ball allows the protrusion to relate to the three dimensional location of the healing ball therefore the precise 3 dimensional location of the recess 314.

The exemplary recess 314 has at least two adjacent walls that form an angle relative to one another such that the recess is not merely circular. In the exemplary embodiment depicted there are six flat-edged walls that form the recess 314 to provide a hexagonal recess. In other embodiments, more or fewer flat-edged walls are provided. Such walls allow for the engagement of a socket or other tool whereby the implant can be mechanically inserted into the jawbone. In other embodiments (FIG. 3C) the recess or internal cavity or shaft, consist of a threaded portion, and a two part interlock chamber contiguous to the said threaded portion including multi-lobed surfaces in a first part, and a plurality of lobes, slots or grooves in a second part. The anti-rotational part completes a series of functions. First, its main function is to prevent the piece from rotating in relation to the dental implant. Furthermore, in the event that the piece is a prosthetic element, the anti-rotational part guarantees the resistance of the implant during the insertion phase of the prosthetic element and facilitate the positioning and insertion of the prosthetic element, creating a guide to facilitate the assembly of the prosthetic element on the dental implant. Any protrusions may be connected to a dental implant, such that the implant and the protrusions are capable of being connected to each other by an internal connection. The protrusion behaves as a male element and the dental implant recess behaves as a female element. The inventive internal connection guarantees great strength and resists biting forces over the long term. Yet in another embodiment (FIG. 3C) the female internal connection is in the form of a spline. In the exemplary embodiment there are six splines and the male protrusions have equal number of splines in order to mate into a stable interconnections. Yet in another embodiment, the recess consist of a threaded portion disposed beneath two adjacent flat-edged walls portion and further dispose beneath a tapered portion whereby the top tapered portion terminate to the neck and surface of implant. The one or more illustrative embodiments are intended only to provide a brief overview of subject matter disclosed herein. The combination of different engaging geometric configurations such as lobes, flat edged walls, cylinders, taper, conical, triangular, square, octagonal, polygonal, threads, splines, gears and the different vertical disposition of each or in combination thereof can be make to match the recess and protrusions to form a stable connection or mate between the implants and the abutment/prosthesis. See also U.S. Pat. Nos. 4,960,381; 6,733,291; 7,108,510; 8,123,524; 5,897,319; 7,108,510; 6,537,070; 7,396,231; 5,195,892; and patent publications 2012/0310286; 2012/0021381; 2013/0183637; 2008/0261176; the entire content of which is hereby incorporated by reference into this specification.

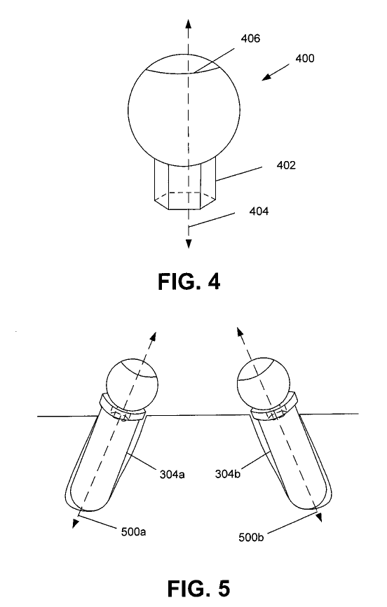

In step 208 of method 200, the patient's mouth is digitally mapped with a computer to produce a three dimensional map including a map of the location of the implants of each hole. In this fashion, the relative position of each of the implants is determined. In one embodiment, a scan ball 400 is attached to the recess 314 of each implant 304 to aid in the determination of the relative position. An exemplary scan ball 400 is shown in FIG. 4. The scan ball 400 includes a protrusion 402 with a shape that is configured to mate with the shape of recess 314. The protrusion 402 may be formed from metal, porcelain, acrylic, zirconia, titanium and the like. The scan ball 400 is formed from Peek, metal or other scan friendly materials. In one embodiment, an impression is cast based on the digital map. The impression replicates the patient's edentulous space and is useful in subsequent steps when creating a final prosthesis.

In the example depicted in FIG. 4, the recess 314 of the implant 304 is a hexagonal recess and the protrusion 402 is a hexagonal protrusion. During step 208, the longitudinal axis of each implant can be determined by examining the orientation of the scan ball 400. For example, and with reference to FIG. 5, a longitudinal axis 500a is determined for an implant 304a whereas a different longitudinal axis 500b is determined for an implant 304b. To facilitate such a determination, the scan ball 400 may include optical markers that permit a computer to identify the longitudinal axis 404 of the protrusion 402. In the embodiment of FIG. 4, the optical marker is a circular optical marker 406 that may be processed by the computer during step 208. Other suitable optical markers may also be used, including colored surfaces with various patterns. The scan ball 400 extends the height of the implant 304 to facilitate the accurate optical registration of the scan balls and implants in the jawbone in relationship to oral structures, such as existing dentition, oral tissues anatomical landmarks. A digital dental map is produced with laser, optical, coherence tomography, wherein the scan balls 400 facilitate integrated acquisition of the implants 304 accurately. Other imaging devices and methods that allow the non-contact, non-invasive capture or re-constitution of the relative orientation of the multiple implants in the jawbone are also contemplated for use with the present method. A digital map is formed from dental software acquired by the scanned image. Typical workflow from laser, optical intra-oral scanned images produce highly accurate computer-aided drawings (CAD) files, build and edit virtual model for use in computer-aided manufacturing (CAM). With available open source CAD/CAM software, a final prosthesis can be milled from dental materials such as but not limited to fabricate a multitude of restorations including inlays, onlays, veneers, full crowns and bridges. The restorations are fabricated from a number of materials including resin, porcelain and acrylic using prefabricated milling blocks of the chosen material (e.g. zirconia and titanium). Other suitable materials include lithium disilicate glass ceramic, hybrid cerics, leucite-reinforced glass ceramics, nickel-free cobalt chrome alloys and the like. The dental implant system and associated process enable a practitioner to form a final prosthesis, including an infinite number of facsimiles of the final prosthesis, based on a laser, 3D optical intraoral or table top scan impression that is designed and manufactured from CAD CAM processes to produce and insert the final prosthesis.

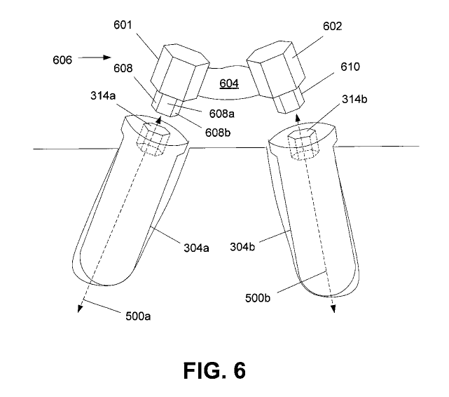

Referring to FIG. 6, in step 210, a first abutment 601 is attached to a second abutment 602 with a bridge 604 to form a dental prosthesis 606. An abutment is that portion of a dental prosthesis that removably connects to the implant and remains disposed above the patient's jawbone and gum line. The abutment is configured to receive a secondary prosthesis, such as an artificial tooth. The secondary prosthesis may be attached to the abutment using, for example, dental cement. The first abutment 601 and second abutment 602 have respective first and second protrusions 608, 610 which have at least two adjacent flat-edged walls (e.g. 608, 608b). The first and second protrusions 608, 610 extend below the bridge 604. In one embodiment, the first and second protrusions 608, 610 extend below the abutment for a length of about 1-30 mm so as not to interfere with transitional dentures. In the exemplary embodiment of FIG. 6, there are six flat-edged walls that form hexagonal protrusions. In other embodiments, more or fewer flat-edged walls are provided. The flat-edged walls provide an indexing position, also referred to as a timed position, and permit the protrusions to be fixedly inserted into a corresponding recess while preventing the protrusions from rotating in the recess. For example, with six flat-edged walls present, six indexed positions are provided. The bridge 604 may be formed from any tooth looking or functioning materials such as Zirconia, porcelain, titanium, acrylic teeth forming materials, plastic, polymers, and laser consolidated processes.

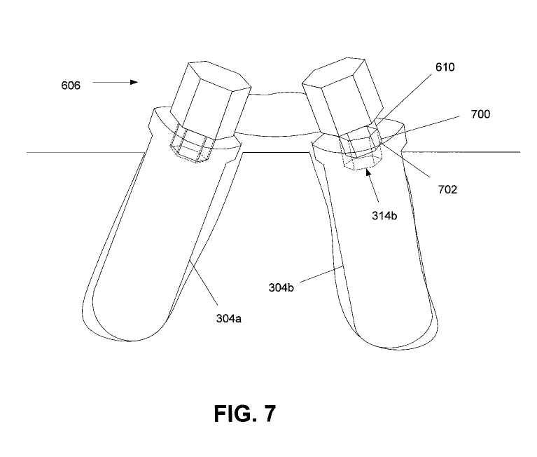

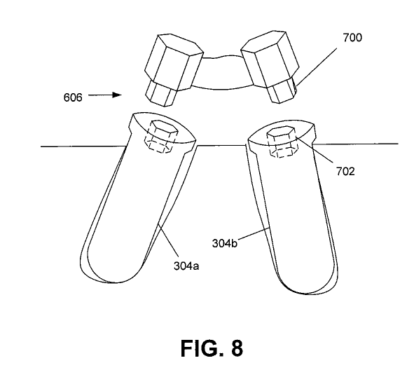

In practice, the protrusions 608, 610 often do not perfectly align with the recesses 314a, 314b of the implants 304a, 304b after the bridge 604 is formed. Due to the presence of the rigid bridge 604, one cannot simply re-orientate the angle of insertion. It is undesirable to individually place the implants in the jawbone and thereafter form the bridge as this is a time consuming and costly process. To obviate the need for such a step, the abutments 601, 602 and their corresponding protrusions 608, 610 may be machined from a prefabricated common piece. For example, in one embodiment, the prefabricated common piece may provide the same hexagonal protrusion on all such pieces. Then, after the bridge 604 has been formed, comparison of the prosthesis 604 to the digital map produced in step 208 informs the practitioner which sections of which protrusion should be removed to provide a common path of insertion. For example, and with reference to FIG. 7, it can be determined from this digital map that a section 700 of the protrusion 610 is incorrectly contacting section 702 of the recess 314b, thereby preventing the prosthesis 606 from being correctly fit with both implants 304a and 304b. In step 212, based on the three dimensional map, at least a section 700 of the protrusion 610 is machined to produce a common path of insertion of the first and second protrusions 608, 610 into the recesses 314a, 314b of the first implant 304a and the second implant 304b. FIG. 7 shows the section 700 as incompatible with the recess while FIG. 8 shows the prosthesis 606 after section 700 has been removed by machining. In FIG. 7 the jawbone and implants are shown for illustrative purposes only. It should be noted that the practitioner can determine which sections to remove by machining based on the digital map and there is no need to engage in a time consuming and costly trial-and-error process with the actual patient's jawbone. The disclosed method circumvents the need to fabricate intermediary components such as individual, separate abutments, abutment screws and other custom components in order to establish a “common path of insertion” to allow insertion of the prosthesis into all recesses simultaneously.

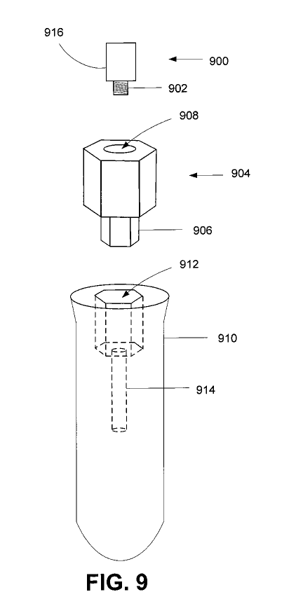

In step 214, once the protrusion has been machined, the prosthesis 606 may be properly inserted into recesses 314a, 314b of the patient's jawbone via a common path of insertion. In step 216, at least one of the protrusions is affixed to its corresponding recess, thereby attaching the dental prosthesis. Various attachment mechanism may be used including dental cement and/or screw attachments (see FIG. 9).

FIG. 9 depicts a screw attachment 900 that comprises threads 902. An abutment 904 is show that includes a protrusion 906. The abutment 904 comprises a bore 908 that traverses the length of the abutment 905 and the protrusion 906. An implant 910 includes a recess 912 with a threaded bore 914 disposed below the recess 912. In use, the threads 902 of the screw attachment 900 pass through the abutment 904 and attach to the threaded bore 914. Upon tightening screw attachment 900, the abutment 904 is securely affixed to the implant due to the presence of header 916 atop threads 902. Header 916 has a diameter that is wider than the diameter of bore 908.

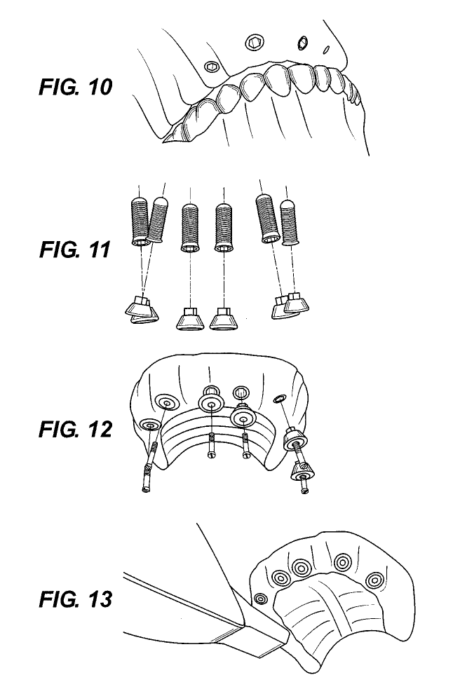

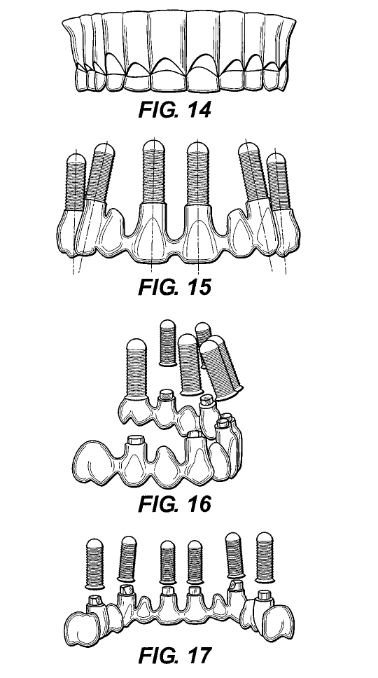

FIGS. 10 to 17 depict the execution of another exemplary method wherein the prosthesis is formed from pure grade V titanium, FIG. 10 depicts implants after they have been installed into a patient's upper jawbone. Hexagonal recesses are depicted in the exemplary embodiment. In FIG. 11, a schematic depiction of the relative orientation of the various implants is shown with the longitudinal axes illustrated. A plurality of scan balls are also shown. In FIG. 12, the geometrical shaped scan balls are securely attached to the implants using screw attachments. Each scan ball has an optical marker or geometrical shape on its surface. In the embodiment depicted, the optical marker is a hexagonal colored pattern that is disposed on the upper surface of the scan ball. In FIG. 13, an optical scanner is used to digitally map the location of the optical markers and thereby determine the relative orientation of the various implants. An exemplary digital map is depicted in FIG. 14. FIG. 14 shows the output on a computer screen of a digital map of the patient's mouth. In FIG. 15, the map has been altered to remove the gums and show the relative orientation of the various implants as they extend into the jawbone. A digital bridge is also created in the computer using the un-machined protrusion geometries. In FIG. 16, the computer determines which portions of the protrusions must be machined to produce a common path of insertion. In FIG. 17 a prosthesis with appropriately machined protrusions is provided that has a common path of insertion into the implants. With a digital map of the prosthesis, an actual prosthesis may be formed using convention fabrication techniques, such as lathing. In one such embodiment, a common piece (e.g. a block of a given material) is lathed to produce a monolithic prosthesis.

One embodiment of the present invention also contemplates a method of forming a dental prosthetic comprising fixing a stud element in a predetermined site, placing a removable protective element on the stud element and forming a first impression over the protective element at the predetermined site. The method also includes removing the protective element from the stud element with the first impression, mounting an abutment in the protective element contained in the first impression, forming a second impression over the abutment such that the second impression substantially replicates the predetermined site, and creating a prosthesis by relying on information provided by the second impression.

Another embodiment of the present invention contemplates a method of forming a dental prosthetic comprising providing a first impression which replicates a dental site, inserting a fixation element into the first impression, providing a second impression which replicates the dental site and retains the fixation element and modifying the fixation element on the second impression as needed so as to provide sufficient information to create the prosthetic.

Yet another embodiment of the present invention contemplates a model for creating a dental prosthetic comprising a form replicating the region of an edentulous space within a patient's mouth, the form having an analog abutment protruding from the region, and the analog abutment having a modification created to ensure insertability and removability of a prosthetic within a patient's mouth.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for attaching a dental prosthesis having multiple abutments, the method comprising:
forming a plurality of holes in a patient's jawbone during a single surgery;
installing an implant into each of the holes including at least a first implant and a second implant, each of the implants having a threaded base and a top portion, the top portion having a recess having at least two adjacent walls disposed below a top surface of the implant;
permitting the patient's jawbone to heal thereby affixing the implants into the holes;
digitally mapping the patient's mouth with a computer to produce a three dimensional map including a map of the location of the top portion of the implant of each hole, to determine the relative position of each of the implants;
attaching a first abutment to a second abutment with a bridge to form a dental prosthesis, the first abutment and second abutment having respective first and second protrusions, each having at least two adjacent walls that extend below the bridge;
machining, based on the three dimensional map, at least a section of the first protrusion to produce a common path of insertion of the first and second protrusions into the recesses of the first implant and the second implant;
inserting the first and second protrusions into the first and second recesses by way of the common path of insertion; and
affixing the first protrusion to the first recess and the second protrusion to the second recess, thereby attaching the dental prosthesis.

2. The method as recited in claim 1, wherein the implant is monolithic.

3. The method as recited in claim 2, wherein the recess of the implant comprises a hexagonal recess with six flat-edged walls including the two adjacent walls.

4. The method as recited in claim 2, further comprising a step of attaching a scan ball with an optical marker to the recess of each implant, the step of digitally mapping the patient's mouth comprising digitally mapping the optical marker to determine a longitudinal axis of the recess of each implant.

5. The method as recited in claim 2, further comprising the step of attaching a healing abutment to the implant during the step of permitting the patient's jawbone to heal.

6. The method as recited in claim 2, wherein, after the step of machining, the first protrusion and the second protrusion have different geometries relative to one another.

7. A method for attaching a dental prosthesis having multiple abutments, the method comprising:
forming a plurality of holes in a patient's jawbone during a single surgery;
installing an implant into each of the holes including at least a first implant and a second implant, each of the implants having a threaded base and a top portion, the top portion having a recess having at least two adjacent walls disposed below a top surface of the implant;
permitting the patient's jawbone to heal thereby affixing the implants into the holes;
digitally mapping the patient's mouth with a computer to produce a three dimensional map including a map of the location of the top portion of the implant of each hole, to determine the relative position of each of the implants;
machining, based on the three dimensional map, a dental prosthesis comprising a first abutment attached by a bridge to a second abutment, the first and second abutment having respectively first and second protrusions, the protrusions being machined to produce a common path of insertion of the first and second protrusions into the recesses of the first implant and the second implant;
inserting the first and second protrusions into the first and second recesses by way of the common path of insertion;
affixing the first protrusion to the first recess and the second protrusion to the second recess, thereby attaching the dental prosthesis.

8. The method as recited in claim 7, wherein the implant is monolithic.

9. The method as recited in claim 8, wherein the recess of the implant comprises a hexagonal recess with six flat-edged walls including the two adjacent walls.

10. The method as recited in claim 8, further comprising a step of attaching a scan ball with an optical marker to the recess of each implant, the step of digitally mapping the patient's mouth comprising digitally mapping the optical marker to determine a longitudinal axis of the recess of each implant.

11. The method as recited in claim 8, further comprising the step of attaching a healing abutment to the implant during the step of permitting the patient's jawbone to heal.

12. The method as recited in claim 8, wherein the step of machining produces the dental prosthesis by lathing.

13. The method as recited in claim 8, wherein, after the step of machining, the first protrusion and the second protrusion have different geometries relative to one another.

14. The method as recited in claim 8, wherein the two adjacent walls are two adjacent flat-edged walls.

15. The method as recited in claim 8, wherein the two adjacent walls are one flat edge wall and one arcuate wall.

16. The method as recited in claim 8, wherein the two adjacent walls are a first pair of two adjacent flat-edged walls, the recess further comprising a second pair of two adjacent flat-edged walls, the first pair and the second pair being separated by an arcuate wall.

17. A dental prosthesis having multiple abutments, the dental prosthesis comprising:
a plurality of abutments, each joined to at least one adjacent abutment by a bridge, each abutment comprising a protrusion for insertion into a recess of a dental implant;
wherein the plurality of abutments includes a first abutment and a second abutment with respective first and second protrusions, the first protrusion has a first geometry and the second protrusion has a second geometry, the first and second geometry being different;
wherein the dental prosthesis is monolithic.
